(19) United States
(12) Patent Application Publication
(10) Pub. No.: US 2012/0306938 A1
(43) Pub. Date: Dec. 6, 2012

(54) LCD DEVICE AND DRIVING METHOD THEREOF

(75) Inventor: Dongsheng Guo, Shenzhen (CN)

(73) Assignee: SHENZHEN CHINA STAR OPTOELECTRONICS TECHNOLOGY CO., LTD., Shenzhen (CN)

(21) Appl. No.: 13/375,704

(22) PCT Filed: Jun. 8, 2011
(86) PCT No.: PCT/CN11/75474

§ 371 Date: Dec. 1, 2011

(30) Foreign Application Priority Data
Jun. 2, 2011 (CN) 201110147570.X

(51) Int. Cl. G09G 5/10; G09G 3/36

(52) U.S. Cl. 345/690; 345/102

(57) ABSTRACT

Disclosed are a LCD device and a driving method thereof. A counting control unit is used for outputting control signals periodically. A determining unit receives the video signal and the control signal and determines if it is necessary to determine the video signal of a current frame is identical with the video signal of a previous frame based on the control signal. If it is not necessary, the determining unit commands light sources to be turned on. If it is necessary, the determining unit commands the light sources to be turned on when the video signal of the current frame and the video signal of the previous frame are different, and to be turned off when the video signal of the current frame and the video signal of the previous frame are identical. Through the above mentioned mechanism, power consumption of the LCD is greatly reduced.

### BACKGROUND OF THE INVENTION

1. Field of the Invention

The present invention relates to a liquid crystal display (LCD) device and a driving method thereof.

2. Description of the Prior Art

Owing to their low-profile, thin, and lightweight features, LCD devices have replaced cathode ray tubes (CRTs) in many applications and becomes the mainstream display devices in recent years. LCD panels are widely used in electronic devices such as mobile phones, personal digital assistants (PDAs), digital cameras, computer screens, notebook screens, etc.

Traditionally, LCD devices are operated under a frame rate of 60 Hertz (Hz). For the purpose of displaying better dynamic images, LCD devices have been developed to be operated under a frame rate of 120 Hz and 240 Hz. The LCD devices operated under a frame rate of 120 Hz or 240 Hz have better display performance than those operated under a frame rate of 60 Hz do. Compared with the LCD device operated under a low frame rate, the LCD device operated under a high frame rate can show more images during a fixed period of time, making dynamic images smoother. In other words, a high frame rate can enhance the quality of dynamic images.

Refer to FIG. 1 showing a diagram of variations in an image when an LCD device equipped with a frame rate of 60 Hz, 120 Hz, and 240 Hz displays an image which seldom changes according to a conventional technology. The 60 Hz frame rate means that one frame occurs every 1/60 of a second; the 120 Hz frame rate means that two frames occur every 1/60 of a second; the 240 Hz frame rate means that four frames occur every 1/60 of a second. For the LCD device with the 60 Hz frame rate, one image block moves once when the first frame becomes the second frame. For the LCD device with the 120 Hz frame rate, the image block also moves once when the second frame becomes the third frame, which can be detected from the first frame becoming the third frame. In fact, the image block moves whenever it is on the third frame but does not move whenever it's on the second frame. For the LCD device with the 240 Hz frame rate, the image block also moves once, which can be detected from the first frame becoming the fifth frame. In fact, the image block moves whenever it is on the fifth frame but does not move whenever it's on the second or fourth frame.

Refer to FIG. 2 showing a diagram of variations in an image when the above-mentioned LCD device equipped with a frame rate of 120 Hz and 240 Hz displays an image which seldom changes. For the LCD device with the 120 Hz frame rate, one image block moves once when the first frame becomes the second frame, and the image block moves once again when the second frame becomes the third frame. Relatively, for the LCD device with the 240 Hz frame rate, the image block moves twice too, which can be detected from the first frame becoming the fifth frame. In fact, the image block moves whenever it is on the third and fifth frame but does not move whenever it's on the fourth frame.

As shown in FIG. 1 and FIG. 2, some neighboring frames do not change actually even if the LCD device operated under a higher frame rate (e.g., 120 Hz and 240 Hz) is used to display images under a rarely changing frame. Although the neighboring frames do not change, liquid crystal capacitors still need a stable bias current to get charged, increasing power consumption of the entire LCD device. Therefore, it is an object of the IT industry to strive to reduce power consumption of LCD devices more effectively.

### SUMMARY OF THE INVENTION

Accordingly, an object of the present invention is to provide an LCD device and a driving method thereof capable of turning off light sources temporarily or not outputting a video signal of a current frame to reduce power consumption of LCD devices after determining that the video signal of the current frame is identical with the video signal of a previous frame.

According to the present invention, a liquid crystal display (LCD) device comprising a LCD panel, a processing unit for generating a plurality of video signals of frames, and a backlight module. The LCD device further comprises a counting control unit for periodically outputting control signals and a determining unit. The determining unit is used for receiving the plurality of video signals and the control signals, and for determining whether to judge a video signal of a current frame is similar to that of a previous frame based on the control signals. The determining unit controls light sources in the backlight module turning on when the determining unit determines not to judge whether the video signal of the current frame is similar to that of the previous frame. The determining unit controls light sources in the backlight module turning on when the video signal of the current frame is different from that of the previous frame. The determining unit controls light sources in the backlight module turning off when the video signal of the current frame is similar to that of the previous frame.

In another aspect of the present invention, the LCD device further comprises a timing controller coupling to the processing unit for receiving the plurality of video signals from the processing unit and for transforming the plurality of video signals into digital signals.

In still another aspect of the present invention, the LCD device further comprises a timing controller coupling to the determining unit. The determining unit transmits the plurality of video signals to the timing controller, and then the timing controller transforms the plurality of video signals into digital signals.

In another aspect of the present invention, the LCD device further comprises a timing controller coupling to the determining unit. The determining unit transmits the video signal of a current frame to the timing controller when the light sources in the backlight module turn on. The counting control unit does not output any video signal to the timing controller when the light sources in the backlight module turn off, and then the timing controller transforms the plurality of video signals into digital signals.

In another aspect of the present invention, the counting control unit is a counter for counting a number of the video signals of the frames from the processing unit, the counting control unit outputs a control signal to the determining unit when the number of the frames complies with a predetermined value. The determining unit transmits the video signal of the current frame to the timing controller and outputs the light source turn-on signal to control the light sources in the backlight module turning on when the determining unit receives the control signal, the determining unit judges whether the video signal of the current frame is similar to that of a previous frame when not receiving the control signal. The determining unit does not output any video signal to the timing controller but outputs the light source turn-off signal to turn off the light sources in the backlight module if the video signal of the current frame is similar to that of a previous frame. The determining unit outputs the video signal of the current frame to the timing controller and outputs the light source turn-on signal to turn on the light sources in the backlight module if the video signal of the current frame is not similar to that of a previous frame.

In another aspect of the present invention, the predefined value is set as a function of k(x/60)+1, where x indicates a frame rate of the LCD device, and k is an integer.

In another aspect of the present invention, the counting control unit is a timer for periodically outputting a control signal to the determining unit every one predetermined interval since the video signal of an mth frame, where m is an integer. The determining unit transmits the video signal of the current frame to the timing controller and outputs the light source turn-on signal to control the light sources in the backlight module turning on when the determining unit receives the control signal. The determining unit judges whether the video signal of the current frame is similar to that of a previous frame when not receiving the control signal. The determining unit does not output any video signal to the timing controller but outputs the light source turn-off signal to turn off the light sources in the backlight module if the video signal of the current frame is similar to that of a previous frame. The determining unit outputs the video signal of the current frame to the timing controller and outputs the light source turn-on signal to turn on the light sources in the backlight module if the video signal of the current frame is not similar to that of a previous frame.

In another aspect of the present invention, the predetermined interval is set as a function of x/60, where x indicates a frame rate of the LCD device.

In another aspect of the present invention, a frame rate of the LCD device is 120 Hz or 240 Hz.

According to the present invention, a method of driving an LCD device comprising an LCD panel, a processing unit, a light source, a counting control unit, a determining unit, the comprises the steps of: (a) the processing unit outputting a video signal of ith frame, where i=1 at the beginning; (b) the counting control unit counting a number of a plurality of video signals of frames, and determining whether the number of the plurality of video signals of the frames matches a predetermined value, if so, performing step (c), if not performing step (d); (c) the determining unit controlling the light source turning on, and then performing step (e); (d) the determining unit judging whether the video signal of the ith frame is similar to that of the (i−1)th frame, if so, the determining unit controlling the light source turning off and then performing step (e), if not, the determining unit controlling the light source turning on and then performing step (e); and (e) setting i=i+1, and returning step (a).

In one aspect of the present invention, the LCD device further comprises a timing controller for transforming the plurality of video signals into digital signals, the processing unit outputs the video signal of the ith frame to the determining unit in step (a); the determining unit outputs the video signal of the ith frame to the timing controller when controlling the light source turning on in step (c); the determining unit does not output any video signal to the timing controller, if so in step (d), otherwise the determining unit outputs the video signal of the ith frame to the timing controller, if not in step (d).

In one aspect of the present invention, the counting control unit is a counter for counting a number of the video signals of the frames from the processing unit.

In one aspect of the present invention, the predefined value is set as a function of k(x/60)+1, where x indicates a frame rate of the LCD device, and k is an integer.

In one aspect of the present invention, a frame rate of the LCD device is 120 Hz or 240 Hz.

According to the present invention, a method of driving an LCD device comprising an LCD panel, a processing unit, a light source, a counting control unit, a determining unit The method comprises the steps of: (a) the processing unit outputting a video signal of ith frame, where i=1 at the beginning; (b) the counting control unit periodically outputting a control signal to the determining unit every one predetermined interval since a video signal of an mth frame, where m is a positive integer; (b) performing step (c) if the determining unit receives the control signal; otherwise performing the step (d); (c) the determining unit controlling the light source turning on, and then performing step (f); (d) the determining unit judging whether the video signal of the ith frame is similar to that of the (i−1)th frame, if so, the determining unit controlling the light source turning off and then performing step (e), if not, the determining unit controlling the light source turning on and then performing step (e); and (e) setting i=i+1, and returning step (a).

In one aspect of the present invention, the LCD device further comprises a timing controller for transforming the plurality of video signals into digital signals; the determining unit outputs the video signal of the ith frame to the timing controller when controlling the light source turning on in step (c); the determining unit does not output any video signal to the timing controller and controls the light source turning off, if so step (d); otherwise the determining unit outputs the video signal of the ith frame to the timing controller and controls the light source turning on, if not in step (d).

In one aspect of the present invention, the predetermined interval is set as a function of (x/60)+1, where x indicates a frame rate of the LCD device.

In one aspect of the present invention, a frame rate of the LCD device is 120 Hz or 240 Hz.

In contrast to the prior art, the present invention provides an LCD device and a driving method thereof capable of determining if the video signal of the current frame is identical with the video signal of the previous frame by using a determining unit. After determining that the video signal of the current frame and the video signal of the previous frame are the same, the LCD device turns off light sources temporarily or does not output the video signal of the current frame to a timing controller so that the LCD panel does not display any images. The present invention is used in an LCD device featuring high frame rates, so human eyes cannot detect that the frame is discontinuous even though no light is output under an unchanged frame. In this way, power consumption of the LCD device is reduced while image quality of the LCD device still maintain stable.

These and other features, aspects and advantages of the present disclosure will become understood with reference to the following description, appended claims and accompanying figures.

### BRIEF DESCRIPTION OF THE DRAWINGS

FIG. 1 shows a diagram of variations in an image when an LCD device equipped with a frame rate of 60 Hz, 120 Hz, and 240 Hz displays an image which seldom changes according to a conventional technology.

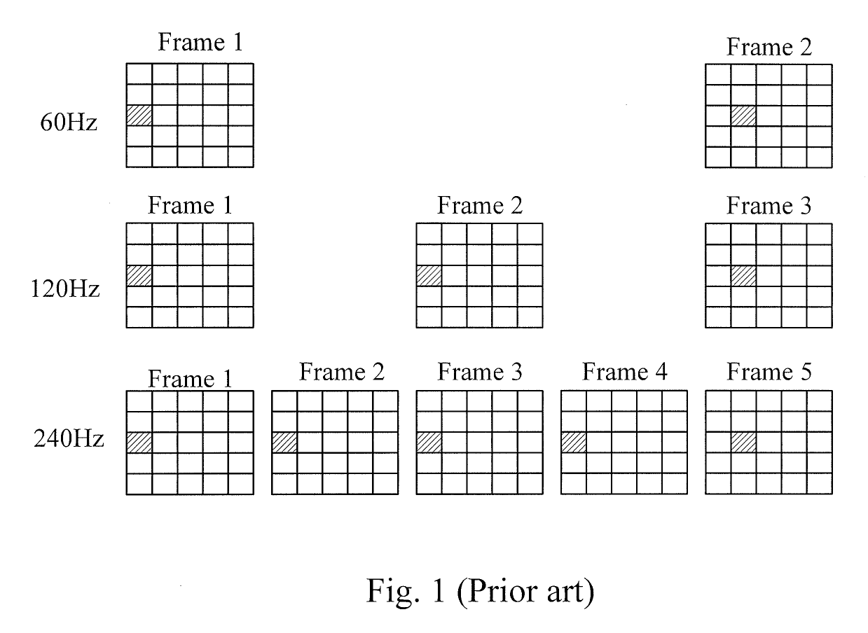

FIG. 2 shows a diagram of variations in an image when the above-mentioned LCD device equipped with a frame rate of 120 Hz and 240 Hz displays an image which seldom changes.

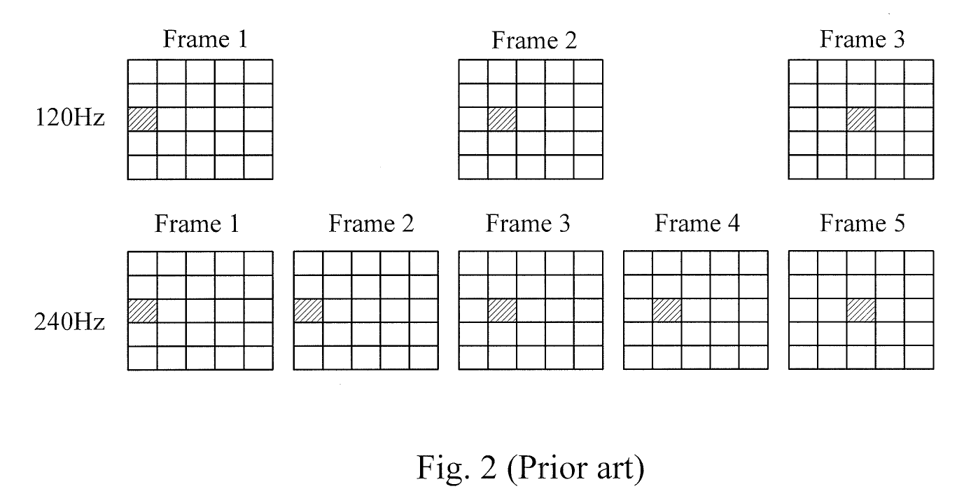

FIG. 3 shows a circuit schematic diagram of a liquid crystal display device according to a first embodiment of the present invention.

FIG. 4 shows a flow chart of a driving method of the LCD device according to the present invention.

FIG. 5 illustrates a comparison between the actual image and outputted image from the processing unit of the LCD device operated at a frame rate of 120 Hz according to a second embodiment of the present invention.

FIG. 6 illustrates a comparison between the actual image and outputted image from the processing unit of the LCD device operated at a frame rate of 240 Hz according to a second embodiment of the present invention.

FIG. 7 illustrates another comparison between the actual image and outputted image from the processing unit of the LCD device operated at a frame rate of 240 Hz according to a second embodiment of the present invention.

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

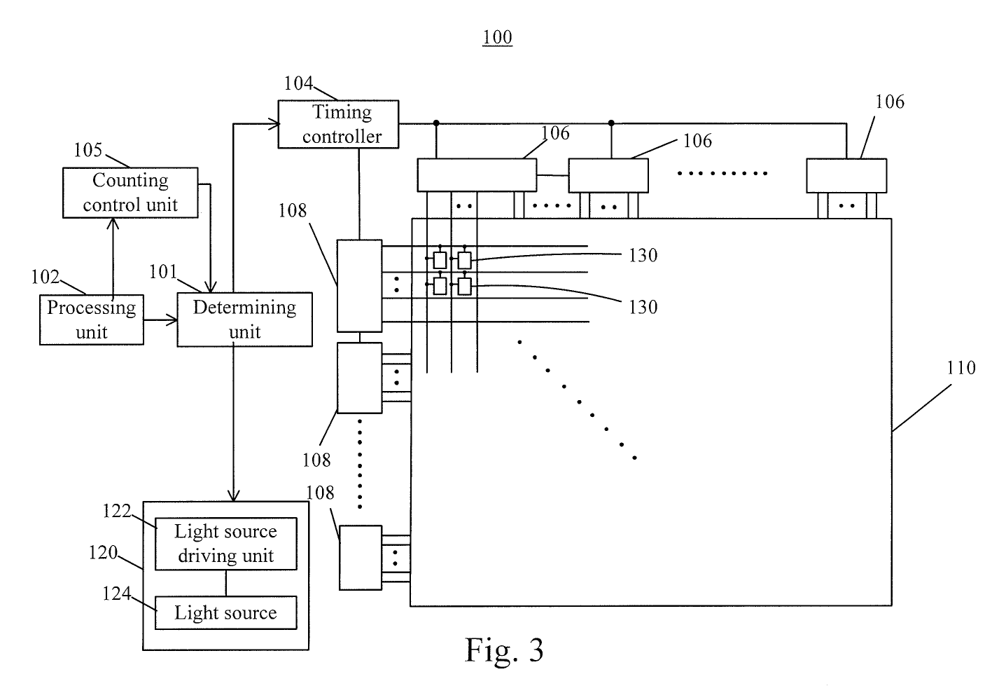

Referring to FIG. 3 showing a circuit schematic diagram of a liquid crystal display (LCD) device 100 according to a first embodiment of the present invention, the LCD device 100 comprises a determining unit 101, a processing unit 102, a counting control unit 105, a timing controller 104, a plurality of source drivers 106, a plurality of gate drivers 108, a backlight module 120, and a LCD panel 110. The LCD panel 110 comprises a plurality of pixels 130. The LCD device 100 is operated under a frame rate of 120 Hz or 240 Hz.

The processing unit 102 may be a central processor of a personal computer or of a notebook computer, and is used for outputting data signal for showing multiple frames to the determining unit 101. The counting control unit 105 may be a counter for counting a number of frames based on the data signal from the processing unit 102. When the number of frames matches a predetermined value, the counting control unit 105 outputs a first control signal to the determining unit 101; otherwise, the counting control unit 105 outputs a second control signal to the determining unit 101. In this embodiment, the predetermined value is set as k(x/60)+1 where x indicates the frame rate and k is a natural number, i.e. k=0,1,2,3. For example, the predetermined value is 1, 3, 5, 7, when x=120 Hz; or the predetermined value is 1, 5, 9, 13 . . . , when x=240 Hz. In another embodiment, the predetermined value is set depending on the users' desire.

The determining unit 101 is used for transmitting a video signal of a current frame received by itself to the timing controller 104. Then, the determining unit 101 decides whether it is necessary to determine if the video signal of the current frame is identical with the video signal of a previous frame or not and outputs a light source control signal correspondingly based on the first and second control signals. The light source control signal may be a light source turn-on signal or a light source turn-off signal. The backlight module 120 comprises a light source driving circuit 122 and a plurality of light sources 124. The plurality of light sources 124 may be light-emitting diodes (LEDs) or cold cathode fluorescent lamps (CCFLs). The plurality of light sources 124 are determined to be turned on or off by the light source driving circuit 122 based on the light source turn-on signal and the light source turn-off signal.

The determining unit 101 transmits the video signal of the current frame to the timing controller 104 no matter which control signal it receives. In addition, the determining unit 101 outputs the light source turn-on signal to the light source driving circuit 122 upon receiving the first control signal, and determines if the video signal of the current frame is identical with the video signal of the previous frame upon receiving the second control signal. If the video signal of the current frame and the video signal of the previous frame are the same, the determining unit 101 outputs the light source turn-off signal to the light source driving circuit 122. If the video signal of the current frame and the video signal of the previous frame are different, the determining unit 101 outputs the light source turn-on signal to the light source driving circuit 122.

The timing controller 104 is used for transmitting frequency pulse signal to the plurality of gate drivers 108. Also, the timing controller 104 is used for receiving the video signal and transforms it into a data signal. The plurality of gate drivers 108 is used for outputting a scan signal based on the frequency pulse signal. The plurality of source drivers 106 transform the data signal into grayscale voltage at different voltage levels. The plurality of source drivers 106 and the plurality of gate drivers 108 may be disposed on a flexible circuit board (not shown) by using a chip on film (COF) technology or on a glass substrate (not shown) by using a chip of glass (COG).

After the frequency pulse signal generated by the timing controller 104 is transmitted to the plurality of gate drivers 108, the plurality of gate drivers 108 outputs a plurality of scan signals to the LCD panel 110 sequentially, so that transistors (not shown) of the plurality of pixels 130 in every row on the LCD panel 110 can be turned on sequentially. While the transistors of the pixels 130 in a row are turned on, the plurality of source drivers 106 output a plurality of grayscale voltages so that liquid crystal capacitors (not shown) of the plurality of pixels 130 in the same row can be charged to the voltage level of the grayscale voltages for displaying different grayscales.

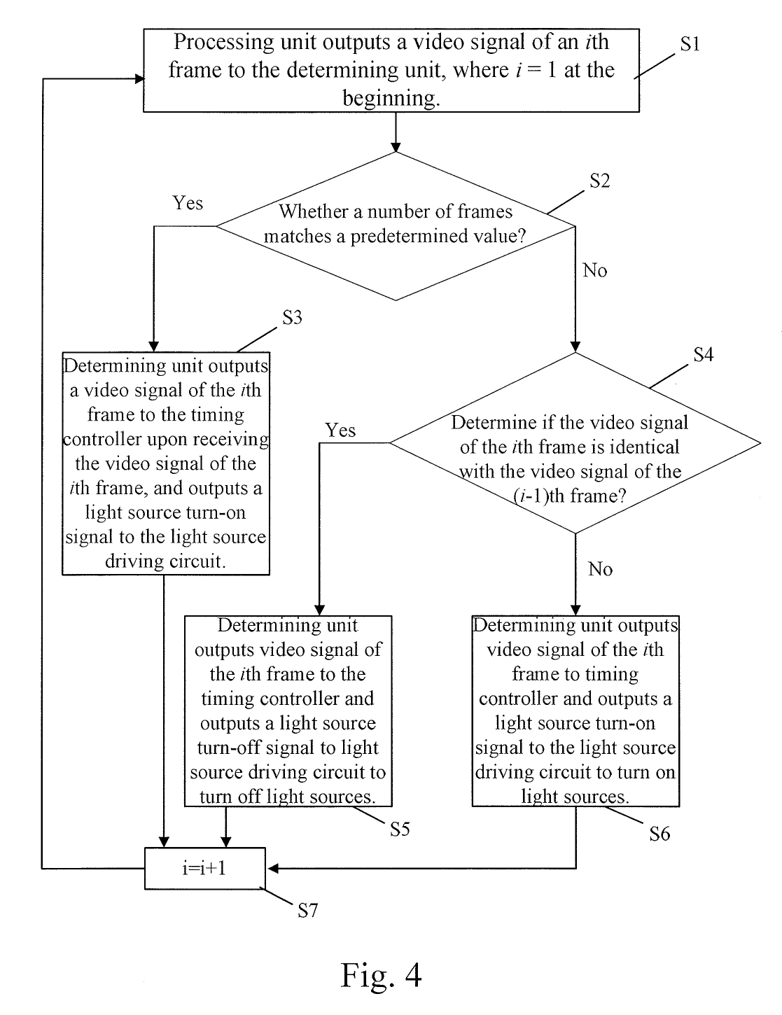

Refer to FIG. 4 showing a flow chart of a driving method of the LCD device 100 according to the present invention. The driving method comprises the following steps:

Step S1: The processing unit 102 outputs a video signal of an ith frame to the determining unit 101, where i=1 at the beginning

Step S2: The counting control unit 105 counts a number of frames output by the processing unit 102 and determines if the number of frames matches a predetermined value. If so, perform Step S3; if not, perform Step S4.

Step S3: The counting control unit 105 outputs the first control signal to the determining unit 101. The determining unit 101 outputs the video signal of the ith frame to the timing controller 104 directly upon receiving the video signal of the ith frame, and outputs a light source turn-on signal to the light source driving circuit 122. Next, perform Step S7.

After receiving the video signal of the ith frame, the timing controller 104 generates a frequency pulse signal and transmits the frequency pulse signal to the plurality of gate drivers 108. Next, the timing controller 104 transforms the video signal of the ith frame into a plurality of data signals and outputs the plurality of data signals to the plurality of source drivers 106. The plurality of gate drivers 108 generate a plurality of scan signals to the LCD panel 110 sequentially based on the frequency pulse signal, so that thin-film transistors (TFTs) embedded inside the plurality of pixels 130 in every row on the LCD panel 110 can be turned on sequentially. While the TFTs of the plurality of pixels 130 in a row are turned on, the plurality of source drivers 106 output a plurality of grayscale voltages so that the liquid crystal capacitors of the plurality of pixels 130 in the same row can be charged to the grayscale voltages for displaying different grayscales. While the ith frame is being displaying, the light source driving circuit 122 turns on the plurality of light sources 124.

Step S4: The counting control unit 105 outputs the second control signal to the determining unit 101. The determining unit 101 determines if the video signal of the ith frame is identical with the video signal of the (i−1)th frame. If so, perform Step S5; if not, perform Step S6.

Step S5: The determining unit 101 outputs the video signal of the ith frame to the timing controller 104 directly and outputs a light source turn-off signal to the light source driving circuit 122. The light source driving circuit 122 turns off the plurality of light sources 124 based on the light source turn-off signal. Next, perform Step S7.

Step S6: The determining unit 101 outputs the video signal of the ith frame to the timing controller 104 and outputs a light source turn-on signal to the light source driving circuit 122. The light source driving circuit 122 turns on the plurality of light sources 124 based on the light source turn-on signal. Next, perform Step S7.

The timing controller 104 commands the LCD panel to display the ith frame according to the plurality of gate drivers 108 and the plurality of source drivers 106.

Step S7: Make i=i+1 and perform Step S1.

In contrast to the conventional technology, the determining unit 101 in the LCD device 100 according to the present invention outputs the light source turn-off signal to the light source driving circuit 122 upon receiving the second control signal and determining that the video signal of the current frame is identical with the video signal of the previous frame. The light source driving circuit 122 turns off the plurality of light sources 124 based on the light source turn-off signal. In this way, the power consumed by the entire LCD device can be greatly reduced. In addition, some images of the same frames can be omitted while the display quality of the frames is not affected because the LCD device is operated under a high refresh rate according to the present invention.

An LCD device according to a second embodiment is similar to the LCD device according to the first embodiment except that, the determining unit 101 according to the second embodiment further determines if the video signal of the current frame should be output to the timing controller 104 based on the two control signals received by the determining unit 101 itself and on the possibility that the video signal of the current frame is identical with the video of the previous frame. That is, the determining unit 101 does not output any video signal to the timing controller 104, and outputs the light source turn-off signal to the light source driving circuit 122 upon receiving the second control signal and determining that the video signal of the current frame is identical with the video of the previous frame; otherwise, the determining unit 101 outputs the video signal of the current frame to the timing controller 104 directly and outputs the light source turn-on signal to the light source driving circuit 122.

A driving method of the LCD device according to the second embodiment is similar to the driving method of the LCD device according to the first embodiment except that, the determining unit 101 does not output any video signal to the timing controller 104, and outputs the light source turn-off signal to the light source driving circuit 122, which turns off the plurality of light sources 124 based on the light source turn-off signal. Next, perform Step S7.

In contrast to the LCD device according to the first embodiment, the determining unit 101 in the LCD device according to the second embodiment does not output any video signal to the timing controller 104 upon receiving the second control signal and determining that the video signal of the current frame is identical with the video signal of the previous frame, which means that the timing controller 104 and the plurality of source drivers 106 do not function. Accordingly, the power consumed by the entire LCD device can be greatly reduced.

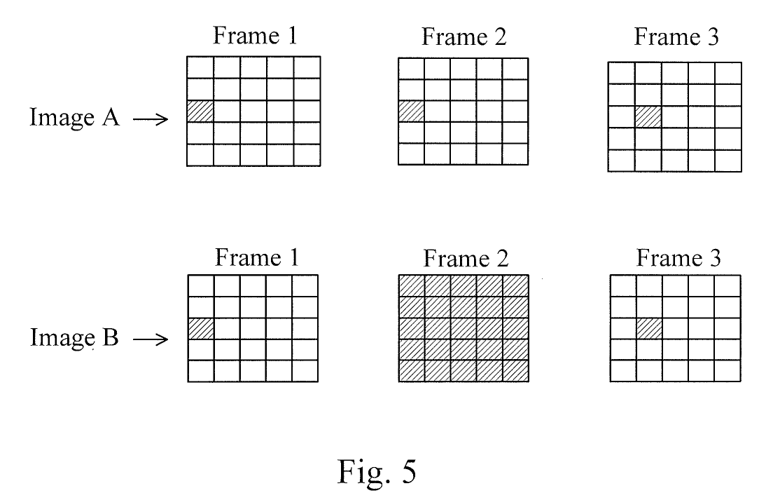

Please refer to FIG. 5 illustrating a comparison between the actual image and outputted image from the processing unit 102 of the LCD device operated at a frame rate of 120 Hz, where the image A indicates the outputted image from the processing unit 102 of the LCD device, and the image B indicates the actual image of the LCD device. Frame 1, frame 2, and frame 3 are displayed as follows:

For displaying frame 1:

Step S1: The processing unit 102 outputs a video signal of an ith frame to the determining unit 101, where i=1 at the beginning; Step S2: The counting control unit 105 counts a number of frames output by the processing unit 102 as 1, complying with the predetermined value; Step S3: The counting control unit 105 outputs the first control signal to the determining unit 101. The determining unit 101 directly outputs the video signal of the frame 1 to the timing controller 104 and then outputs a light source turn-on signal to the light source driving circuit 122. The timing controller 104 cooperating with the gate drivers 108 and the source drivers 106 control the LCD panel 110 to display an image based on the video signal of the frame 1, while the light source driving circuit 122 drives the light sources 124 turning on. Therefore, the LCD device displays the frame 1, as shown in FIG. 5.

For displaying frame 2:

Step S7: i=i+1; return to Step S1; Step S1: The processing unit 102 outputs a video signal of an ith frame to the determining unit 101, where i=2; Step S2: The counting control unit 105 counts a number of frames output by the processing unit 102 as 2, not complying with the predetermined value; Step S4: The counting control unit 105 outputs the second control signal to the determining unit 101. The determining unit 101 determines the video signal of the frame 1 is similar to that of the frame 2; Step S5: The determining unit 101 does not output any video signal to the timing controller 104 but outputs a light source turn-off signal to the light source driving circuit 122 to turn off the light sources 124. Therefore, the LCD device displays a black frame rather than the frame 2, as shown in FIG. 5.

For displaying frame 3:

Step S7: i=i+1; return to Step S1; Step S1: The processing unit 102 outputs a video signal of an ith frame to the determining unit 101, where i=3; Step S2: The counting control unit 105 counts a number of frames output by the processing unit 102 as 3, complying with the predetermined value; Step S3: The counting control unit 105 outputs the first control signal to the determining unit 101. The determining unit 101 directly outputs the video signal of the frame 3 to the timing controller 104 and then outputs a light source turn-on signal to the light source driving circuit 122. Therefore, the LCD device displays the frame 3, as shown in FIG. 5.

As mentioned above, the determining unit 101 does not output the video signal of the frame 2 to the timing controller 104, but outputs a light source turn off signal to the light source driving circuit 122 to turn off the light source 124. As a result, the power of the LCD device is reduced.

In addition, the human fails to perceive a slight variation between frames which are displayed at a high frame rate of 120 Hz. For example, if the video signal of the frame 1 is similar to that of the frame 2, seeing frames 1, 2, and 3 in order is equivalent to seeing the frame 1, a black frame, and frame 3 in order.

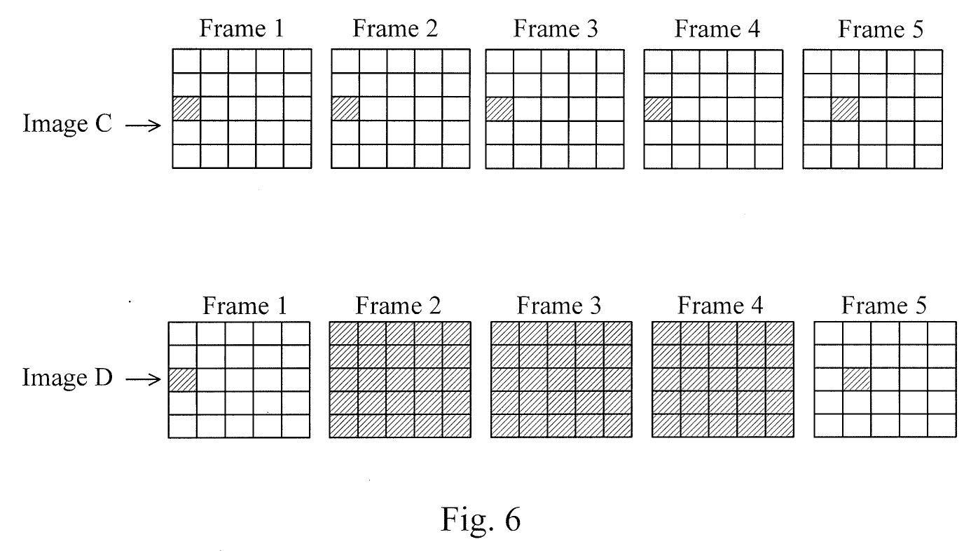

Please refer to FIG. 4 and FIG. 6 illustrating a comparison between the actual image and outputted image from the processing unit 102 of the LCD device operated at a frame rate of 240 Hz according to the second embodiment of the present invention, where the image C indicates the outputted image from the processing unit 102 of the LCD device, and the image D indicates the actual image of the LCD device. Frame 1, frame 2, frame 3, frame 4 and frame 5 are displayed as follows:

For displaying frame 1:

Step S1: The processing unit 102 outputs a video signal of an ith frame to the determining unit 101, where i=1 at the beginning; Step S2: The counting control unit 105 counts a number of frames output by the processing unit 102 as 1, complying with the predetermined value; Step S3: The counting control unit 105 outputs the first control signal to the determining unit 101. The determining unit 101 directly outputs the video signal of the frame 1 to the timing controller 104 and then outputs a light source turn-on signal to the light source driving circuit 122. Therefore, the LCD device displays the frame 1, as shown in FIG. 6.

For displaying frame 2:

Step S7: i=i+1; return to Step S1; Step S1: The processing unit 102 outputs a video signal of an ith frame to the determining unit 101, where i=2; Step S2: The counting control unit 105 counts a number of frames output by the processing unit 102 as 2, not complying with the predetermined value; Step S4: The counting control unit 105 outputs the second control signal to the determining unit 101. The determining unit 101 determines the video signal of the frame 1 is similar to that of the frame 2; Step S5: The determining unit 101 does not output any video signal to the timing controller 104 but outputs a light source turn-off signal to the light source driving circuit 122 to turn off the light sources 124. Therefore, the LCD device displays a black frame rather than the frame 2, as shown in FIG. 6.

Because the method of displaying frames 3 and 4 is identical to that of displaying frame 2, no more detailed description is introduced.

Also, because the method of displaying frame 5 is identical to that of displaying frame 1, no more detailed description is introduced.

As mentioned above, the determining unit 101 does not output the video signal of the frames 2, 3, and 4 to the timing controller 104, but outputs a light source turn off signal to the light source driving circuit 122 to turn off the light source 124. As a result, the power of the LCD device is reduced.

In addition, the human fails to perceive a slight variation between frames which are displayed at a high frame rate of 240 Hz. For example, if the video signals of the frames 1, 2, 3, and 4 are identical, seeing the frames 1, 2, 3, 4, and 5 in order is equivalent to seeing the frame 1, three consecutive black frames, and the frame 5 in order.

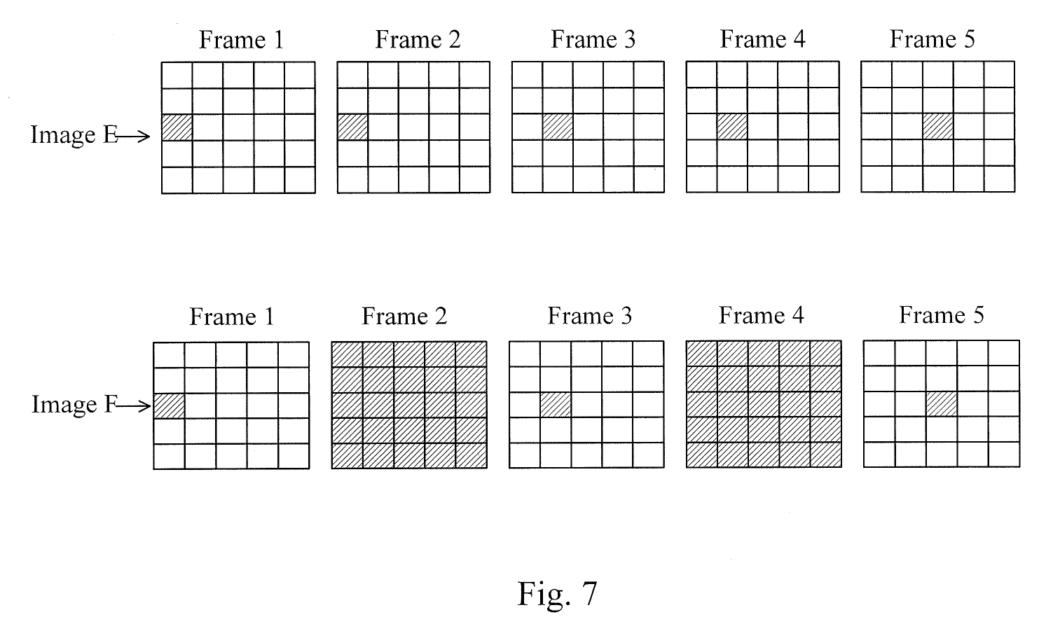

Please refer to FIG. 4 in conjunction with FIG. 7 illustrating another comparison between the actual image and outputted image from the processing unit 102 of the LCD device operated at a frame rate of 240 Hz according to a second embodiment of the present invention, where the image E indicates the outputted image from the processing unit 102 of the LCD device, and the image F indicates the actual image of the LCD device. Frames 1, 2, 3, 4 and 5 are displayed as follows:

For displaying frame 1:

Step S1: The processing unit 102 outputs a video signal of an ith frame to the determining unit 101, where i=1 at the beginning; Step S2: The counting control unit 105 counts a number of frames output by the processing unit 102 as 1, complying with the predetermined value; Step S3: The counting control unit 105 outputs the first control signal to the determining unit 101. The determining unit 101 directly outputs the video signal of the frame 1 to the timing controller 104 and then outputs a light source turn-on signal to the light source driving circuit 122. Therefore, the LCD device displays the frame 1, as shown in FIG. 7.

For displaying frame 2:

Step S7: i=i+1; return to Step S1; Step S1: The processing unit 102 outputs a video signal of an ith frame to the determining unit 101, where i=2; Step S2: The counting control unit 105 counts a number of frames output by the processing unit 102 as 2, not complying with the predetermined value; Step S4: The counting control unit 105 outputs the second control signal to the determining unit 101. The determining unit 101 determines the video signal of the frame 1 is similar to that of the frame 2; Step S5: The determining unit 101 does not output any video signal to the timing controller 104 but outputs a light source turn-off signal to the light source driving circuit 122 to turn off the light sources 124. Therefore, the LCD device displays a black frame rather than the frame 2, as shown in FIG. 7.

For displaying frame 3:

Step S1: Step S7: i=i+1; return to Step S1; Step S1: The processing unit 102 outputs a video signal of an ith frame to the determining unit 101, where i=3; Step S2: The counting control unit 105 counts a number of frames output by the processing unit 102 as 3, not complying with the predetermined value; Step S4: The counting control unit 105 outputs the second control signal to the determining unit 101. The determining unit 101 determines that the video signal of the frame 2 is different from that of the frame 3; Step S6: The determining unit 101 outputs the video signal of the frame 3 to the timing controller 104 and then outputs a light source turn-on signal to the light source driving circuit 122 to turn on the light source 124; Therefore, the LCD device displays the frame 3, as shown in FIG. 7.

For displaying frame 4:

Step S7: i=i+1; return to Step S1; Step S1: The processing unit 102 outputs a video signal of an ith frame to the determining unit 101, where i=4; Step S2: The counting control unit 105 counts a number of frames output by the processing unit 102 as 4, not complying with the predetermined value; Step S4: The counting control unit 105 outputs the second control signal to the determining unit 101. The determining unit 101 determines the video signal of the frame 1 is similar to that of the frame 2; Step S5: The determining unit 101 does not output any video signal to the timing controller 104 but outputs a light source turn-off signal to the light source driving circuit 122 to turn off the light sources 124. Therefore, the LCD device displays a black frame rather than the frame 4, as shown in FIG. 7.

Also, because the method of displaying frame 5 is identical to that of displaying frame 1, no more detailed description is introduced.

As mentioned above, the determining unit 101 does not output the video signal of the frames 2 and 4 to the timing controller 104, but outputs a light source turn off signal to the light source driving circuit 122 to turn off the light source 124. As a result, the power of the LCD device is reduced.

In addition, the human fails to perceive a slight variation between frames which are displayed at a high frame rate of 240 Hz. For example, if the video signal of the frame 1 is similar to that of the frame 2 while the video signal of the frame 3 is similar to that of the frame 4, seeing frames 1-5 in order is equivalent to seeing the frame 1, a black frame, the frame 3, a black frame, and the frame 5 in order.

In addition to the LCD device and driving method depicted in the first embodiment and the second embodiment, in another embodiment, the timing controller 104 may directly connect to the processing unit 102 without connecting to the determining unit 101, and receive the video signals of the multiple frames from the processing unit 102.

The counting 105 may output a control signal to the determining unit 101 when the number of frames is consistent with the predetermined value. Otherwise, the counting 105 does not output a control signal to the determining unit 101 when the number of frames is inconsistent with the predetermined value. The determining unit 101 transmits the video signal of the current frame to the timing controller 104 in response to a reception of the control signal, and outputs the light source turn-on signal to the light source driving circuit 122. If the control signal is not received, the determining unit 101 further determines whether the video signal of the current signal is similar to that of previous one frame. If so, the determining unit 101 does not output any video signal to the timing controller 104, but outputs the light source turn-off signal to the light source driving circuit 122. If not, the determining unit 101 outputs the video signal of the current frame to the timing controller 104, and outputs the light source turn-on signal to the light source driving circuit 122.

The counting control unit 105 may be a timer for periodically outputting a control signal every one predetermined interval since the video signal of the mth frame, where m is an integer. Preferably, the predetermined interval is set as a time period of showing x/60 frames, where x indicates a value of the frame rate. For instance, x=120 Hz, the predetermined interval is set as a time period of showing 2 frames; or x=240 Hz, the predetermined interval is set as a time period of showing 4 frames.

The determining unit 101 transmits the video signal of the current frame to the timing controller 104 in response to a reception of the control signal, and outputs the light source turn-on signal to the light source driving circuit 122. If the control signal is not received, the determining unit 101 further determines whether the video signal of the current signal is similar to that of previous one frame. If so, the determining unit 101 does not output any video signal to the timing controller 104, but outputs the light source turn-off signal to the light source driving circuit 122. If not, the determining unit 101 outputs the video signal of the current frame to the timing controller 104, and outputs the light source turn-on signal to the light source driving circuit 122.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A liquid crystal display (LCD) device comprising a LCD panel, a processing unit for generating a plurality of video signals of frames, and a backlight module, characterized in that: the LCD device further comprises a counting control unit for periodically outputting control signals and a determining unit, the determining unit is used for receiving the plurality of video signals and the control signals, and for determining whether to judge a video signal of a current frame is similar to that of a previous frame based on the control signals, the determining unit controls light sources in the backlight module turning on when the determining unit determines not to judge whether the video signal of the current frame is similar to that of the previous frame, the determining unit controls light sources in the backlight module turning on when the video signal of the current frame is different from that of the previous frame, and the determining unit controls light sources in the backlight module turning off when the video signal of the current frame is similar to that of the previous frame.

2. The LCD device of claim 1, characterized in that: the LCD device further comprises a timing controller coupling to the processing unit for receiving the plurality of video signals from the processing unit and for transforming the plurality of video signals into digital signals.

3. The LCD device of claim 1, characterized in that: the LCD device further comprises a timing controller coupling to the determining unit, the determining unit transmits the plurality of video signals to the timing controller, and then the timing controller transforms the plurality of video signals into digital signals.

4. The LCD device of claim 1, characterized in that: the LCD device further comprises a timing controller coupling to the determining unit, the determining unit transmits the video signal of a current frame to the timing controller when the light sources in the backlight module turn on, the counting control unit does not output any video signal to the timing controller when the light sources in the backlight module turn off, and then the timing controller transforms the plurality of video signals into digital signals.

5. The LCD device of claim 4, characterized in that: the counting control unit is a counter for counting a number of the video signals of the frames from the processing unit, the counting control unit outputs a control signal to the determining unit when the number of the frames complies with a predetermined value, the determining unit transmits the video signal of the current frame to the timing controller and outputs the light source turn-on signal to control the light sources in the backlight module turning on when the determining unit receives the control signal, the determining unit judges whether the video signal of the current frame is similar to that of a previous frame when not receiving the control signal, the determining unit does not output any video signal to the timing controller but outputs the light source turn-off signal to turn off the light sources in the backlight module if the video signal of the current frame is similar to that of a previous frame, the determining unit outputs the video signal of the current frame to the timing controller and outputs the light source turn-on signal to turn on the light sources in the backlight module if the video signal of the current frame is not similar to that of a previous frame.

6. The LCD device of claim 5, characterized in that: the predefined value is set as a function of k(x/60)+1, where x indicates a frame rate of the LCD device, and k is an integer.

7. The LCD device of claim 4, characterized in that: the counting control unit is a timer for periodically outputting a control signal to the determining unit every one predetermined interval since the video signal of an mth frame, where m is a positive integer, the determining unit transmits the video signal of the current frame to the timing controller and outputs the light source turn-on signal to control the light sources in the backlight module turning on when the determining unit receives the control signal, the determining unit judges whether the video signal of the current frame is similar to that of a previous frame when not receiving the control signal, the determining unit does not output any video signal to the timing controller but outputs the light source turn-off signal to turn off the light sources in the backlight module if the video signal of the current frame is similar to that of a previous frame, the determining unit outputs the video signal of the current frame to the timing controller and outputs the light source turn-on signal to turn on the light sources in the backlight module if the video signal of the current frame is not similar to that of a previous frame.

8. The LCD device of claim 7, characterized in that: the predetermined interval equals to x/60 frame, where x indicates a frame rate of the LCD device.

9. The LCD device of claim 1, characterized in that: a frame rate of the LCD device is 120 Hz or 240 Hz.

10. A method of driving an LCD device comprising an LCD panel, a processing unit, a light source, a counting control unit, a determining unit, the method comprising the steps of:
(a) the processing unit outputting a video signal of ith frame, where i=1 at the beginning;
(b) the counting control unit counting a number of a plurality of video signals of frames, and determining whether the number of the plurality of video signals of the frames matches a predetermined value, if so, performing step (c), if not performing step (d);
(c) the determining unit controlling the light source turning on, and then performing step (e);
(d) the determining unit judging whether the video signal of the ith frame is similar to that of the (i−1)th frame, if so, the determining unit controlling the light source turning off and then performing step (e), if not, the determining unit controlling the light source turning on and then performing step (e); and
(e) setting i=i+1, and returning step (a).

11. The method of claim 10, characterized in that: the LCD device further comprises a timing controller for transforming the plurality of video signals into digital signals, the processing unit outputs the video signal of the ith frame to the determining unit in step (a); the determining unit outputs the video signal of the ith frame to the timing controller when controlling the light source turning on in step (c); the determining unit does not output any video signal to the timing controller, if so in step (d), otherwise the determining unit outputs the video signal of the ith frame to the timing controller, if not in step (d).

12. The method of claim 10, characterized in that: the counting control unit is a counter for counting a number of the video signals of the frames from the processing unit, the counting control unit determines whether the number of video signals of the frames complies with a predetermined value.

13. The method of claim 12, characterized in that: the predefined value is set as a function of k(x/60)+1, where x indicates a frame rate of the LCD device, and k is an integer.

14. The method of claim 10, characterized in that: a frame rate of the LCD device is 120 Hz or 240 Hz.

15. A method of driving an LCD device comprising an LCD panel, a processing unit, a light source, a counting control unit, a determining unit, the method comprising the steps of:
(a) the processing unit outputting a video signal of ith frame, where i=1 at the beginning;
(b) the counting control unit periodically outputting a control signal to the determining unit every one predetermined interval since a video signal of an mth frame, where m is a positive integer;
(b) performing step (c) if the determining unit receives the control signal; otherwise performing the step (d);
(c) the determining unit controlling the light source turning on, and then performing step (f);
(d) the determining unit judging whether the video signal of the ith frame is similar to that of the (i−1)th frame, if so, the determining unit controlling the light source turning off and then performing step (e), if not, the determining unit controlling the light source turning on and then performing step (e); and
(e) setting i=i+1, and returning step (a).

16. The method of claim 15, characterized in that: the LCD device further comprises a timing controller for transforming the plurality of video signals into digital signals; the determining unit outputs the video signal of the ith frame to the timing controller when controlling the light source turning on in step (c); the determining unit does not output any video signal to the timing controller and controls the light source turning off, if so step (d); otherwise the determining unit outputs the video signal of the ith frame to the timing controller and controls the light source turning on, if not in step (d).

17. The method of claim 15, characterized in that: the predetermined interval is set as a function of (x/60)+1, where x indicates a frame rate of the LCD device.

18. The method of claim 15, characterized in that: a frame rate of the LCD device is 120 Hz or 240 Hz.
